(19) United States
(12) Patent Application Publication
(10) Pub. No.: US 2021/0388266 A1
(43) Pub. Date: Dec. 16, 2021

(54) METHOD OF PREPARING CONDITIONER FOR PROTECTED AGRICULTURE ACIDIC SOIL WITH DISTILLERS' GRAINS AND USE

(71) Applicant: Institute of Applied Ecology, Chinese Academy of Sciences, Shenyang (CN)

(72) Inventors: Jian Ma, Shenyang (CN); Xin Chen, Shenyang (CN)

(21) Appl. No.: 16/945,985

(22) Filed: Aug. 3, 2020

(30) Foreign Application Priority Data
Jun. 11, 2020 (CN) 202010529583.2

(51) Int. Cl. C09K 17/42; A01N 65/08

(52) U.S. Cl. CPC C09K 17/42; C09K 2101/00; A01N 65/08

(57) ABSTRACT

The present invention provides a method of preparing a conditioner for protected agriculture acidic soil with distillers' grains and use of the conditioner. The method includes mixing distillers' grains with water, adjusting a pH to obtain adjusted distillers' grains, mixing the adjusted distillers' grains with an acid protease, and reacting under stirring at 45-50° C. for 22-26 hours to obtain a protease catalyzed substance, adjusting pH of the protease catalyzed substance, mixing with a cellulase, and reacting under stirring at 40-45° C. for 34-38 hours to obtain a cellulase catalyzed substance, filtering the cellulase catalyzed substance to obtain a filtrate, mixing the filtrate with a magnesium oxide (MgO) and then a calcium-containing substance, reacting to obtain a reactant, mixing the reactant with potassium sorbate and sucrose to obtain the conditioner for protected agriculture acidic soil.

### CROSS-REFERENCE TO RELATED APPLICATIONS

This application claims the benefit under 35 U.S.C. § 119 of Chinese Patent Application No. 202010529583.2, filed Jun. 11, 2020, which application is incorporated herein by reference in its entirety.

### FIELD

The present invention belongs to the technical field of transformation of agricultural solid wastes into resources and soil repair, and particularly relates to a method of preparing a conditioner for protected agriculture acidic soil with distillers' grains and use of the conditioner.

### BACKGROUND

Protected agriculture has become a major planting mode in vegetable production in China. Affected by a high-intensity continuous production mode in protected agriculture, surface soil (0-40 cm) in an area with poor soil buffering capacity generally shows obvious acidification after continuous planting for more than 4-5 years, which is not advantageous for crop growth. The main reason is that in order to maintain high output in protected agricultural production, a large amount of organic fertilizers and excessive nitrogen fertilizers are applied, and excessive organic matter and nitrogen accumulates continuously in soil. Based on a high multiple cropping index in protected agriculture, mineralization of organic matter in soil and nitrogen recycle accelerate soil acidification. Specifically, the organic matter forms a water soluble complex with non-acidic cations such as Ca²⁺ and Mg²⁺ in the soil which are easily leached away once dissolved. At the same time, a large amount of acidic groups in the organic matter release H⁺ through dissociation. Thus, there are a large number of negative charge sites on an organic molecule, and the organic matter has a relatively high cation exchange capacity (CEC). Due to a relatively high fertilizer efficiency, ammonium nitrogen fertilizers (for example, ammonium sulfate and urea) are often used in protected agricultural production, and excessive application thereof results in NH₄⁺ which is not absorbed by plants. Such NH₄⁺ generates NO₃⁻ through microbial oxidation in the soil, where one NH₄⁺ produces two H⁺ during nitrification which promotes soil acidification. Moreover, in a production environment, irrigation in protected agriculture only aims at ensuring growth of crops without effective leaching in a natural rainfall. Thus, H⁺ and salt ions in surface soil can hardly be brought into deep soil. In addition, production at a high temperature and a high humidity accelerates soil mineralization, which promotes acidification of the protected agriculture surface soil. Therefore, the protected agriculture surface soil is no longer suitable for planting after long-term continuous planting.

A conventional way to reduce soil acidity and increase soil pH is to apply alkaline materials, such as calcium carbonate (CaCO₃), quicklime, slaked lime, to the soil to provide a base for conjugation with a weak acid substance to neutralize H+ in the soil and form an anion of a weak acid, thereby reducing the acidity of the soil. However, in practical use, alkaline materials need to be applied in a large amount, and fully mixed with the soil to achieve a relatively desired result. For example, in order to increase the pH of a sandy loam soil from 5.0 to 6.0, CaCO₃ needs to be continuously applied in an amount of 1 ton and fully mixed with the soil for more than 2 years. Such measure is easy to implement and economically feasible in a field, but it is not feasible when large equipment for soil turn-over and alkaline material application can hardly work in protected agriculture due to limitations of, for example, pillars, pipelines and areas which are commonly seen under the current production conditions. At the same time, this method needs to be carried out at intervals of crop growth. With a demand of continuous planting cycles all year round in protected agriculture, there is an urgent need of a method of repairing acidic soil during protected agriculture production.

### SUMMARY

In view of this, an objective of the present invention is to provide a method of preparing a conditioner for protected agriculture acidic soil with distillers' grains and use of the conditioner. The conditioner for protected agriculture acidic soil prepared by the method of the present invention can not only repair the soil, but also improve germination rate of a plant.

To achieve the above purpose, the present invention provides the following technical solutions.

The present invention provides a method of preparing a conditioner for protected agriculture acidic soil with distillers' grains, including the following steps:

step 1): mixing distillers' grains with water, adjusting a pH to 4-4.2 to obtain adjusted distillers' grains;

step 2): mixing the adjusted distillers' grains obtained in step 1) with an acid protease, and reacting under stirring at 45-50° C. for 22-26 hours (h) to obtain a protease catalyzed substance;

step 3): adjusting pH of the protease catalyzed substance in step 2) to 4.6-4.8, mixing with a cellulase, and reacting under stirring at 40-45° C. for 34-38 h to obtain a cellulase catalyzed substance; and,

step 4): filtering the cellulase catalyzed substance obtained in step 3) to obtain a filtrate, mixing the filtrate with a magnesium oxide (MgO) and then a calcium-containing substance, reacting to obtain a reactant, and mixing the reactant with potassium sorbate and sucrose to obtain the conditioner for protected agriculture acidic soil.

Preferably, in step 1), a mass ratio of the distillers' grains to the water is 1:(3-5).

Preferably, the distillers' grains have a particle size of 0.3-0.5 mm.

Preferably, in step 2), every 10,000 enzyme activity units of the acid protease is added with an amount of 0.1-0.2% of the dry mass of the adjusted distillers' grains.

Preferably, in step 3), every 10,000 enzyme activity units of cellulase is added with an amount of 0.2-0.5% of the dry mass of the reactant.

Preferably, in step 4), a concentration of the MgO in the filtrate is 0.2-0.4 g/L.

Preferably, the calcium-containing substance includes calcium oxide (CaO) and/or calcium carbonate (CaCO₃), and the calcium-containing substance is added with an amount of 25-40% of the mass of the filtrate.

Preferably, in step 4), a volume of the potassium sorbate is 0.3-0.5% of that of the reactant.

Preferably, in step 4), a mass of the sucrose is 0.1-0.3% of that of the reactant.

The present invention further provides use of a conditioner for protected agriculture acidic soil obtained by the above method in improving a germination rate of a plant.

The present invention provides a method of preparing a conditioner for protected agriculture acidic soil with distillers' grains, which uses distillers' grains as a major raw material. The distillers' grains are enzymatically treated with an acid protease and a cellulase, so that proteins and cellulose in the distillers' grains are converted into amino acids and polysaccharides, respectively. Addition of calcium and magnesium bases neutralizes acids produced during fermentation and pretreatment of the distillers' grains, and forms a composite organic system of calcium, magnesium ions (Ca²⁺, Mg²⁺) and amino acids (RCHNH₂COOH) at the same time. When the conditioner is applied, the amino acids in the system can be directly absorbed by a plant, form CO₂ by microbial oxidation in the soil, and provide energy to stimulate growth of microorganisms in the soil. After the amino acids are absorbed and decomposed, the calcium and magnesium ions in the organic composite system can be adsorbed by the soil colloid and replace H⁺ and Al³⁺ in the soil colloid, which changes the ion composition adsorbed by the soil colloid and reduces acid saturation of the soil. Acetate in the system can react with Al³⁺ and generate Al(CH₃COO)₂OH or Al(OH)₃, which is equivalent to providing a base for conjugation, reducing an ion responsible for soil acidification, and reducing aluminum toxicity. Moreover, free Ca²⁺ and Mg²⁺ can supplement the soil with non-acidic cations which are previously leached away, and can be absorbed by a plant as nutrient ions, thereby effectively supplementing the acidic soil with calcium and magnesium nutrients. Meanwhile, calcium and magnesium ions in the organic system can go downward through leaching along a soil profile to increase a content of an active calcium and pH in the soil and provide a magnesium ion required by plant growth, thus to repair deep soil. It can be said that, application of the soil conditioner formed by design of the technical solution of the present invention in the soil can comprehensively improve the protected agriculture soil which is not suitable for plant growth due to acidification resulted from long term farming and other relative conditions derived from acidification. The conditioner of the present invention can act from various perspectives, for example, H⁺ replacement, soil acid saturation reduction, aluminum toxicity reduction, and calcium and magnesium nutrient supplement. The soil conditioner solves the problem that conventional application of lime materials is mostly limited by depth of soil turn-over and when the soil has a relatively high CEC, only the addition of lime in the soil works in a short term. Based on lack of effective leaching in protected agriculture, the conditioner of the present invention can be used with water to repair the soil, and achieve soil repairing during production to ensure continuous production based on the seldom fallow soil in protected agriculture.

### DETAILED DESCRIPTION

The present invention provides a method of preparing a conditioner for protected agriculture acidic soil with distillers' grains, including the following steps:

step 1): mixing distillers' grains with water, adjusting a pH to 4-4.2 to obtain adjusted distillers' grains;

step 2): mixing the adjusted distillers' grains obtained in step 1) with an acid protease, and reacting under stirring at 45-50° C. for 22-26 h to obtain a protease catalyzed substance;

step 3): adjusting pH of the protease catalyzed substance in step 2) to 4.6-4.8, mixing with a cellulase, and reacting under stirring at 40-45° C. for 34-38 h to obtain a cellulase catalyzed substance; and,

step 4): filtering the cellulase catalyzed substance obtained in step 3) to obtain a filtrate, mixing the filtrate with a magnesium oxide (MgO) and then a calcium-containing substance, reacting to obtain a reactant, and mixing the reactant with potassium sorbate and sucrose to obtain the conditioner for protected agriculture acidic soil.

In the present invention, the source of the distillers' grains is not particularly limited, and conventional distillers' grains left after wine making may be used. In the present invention, the distillers' grains are preferably sorghum distillers' grains or corn distillers' grains. In the present invention, the distillers' grains preferably have a particle size of 0.3-0.5 mm.

In the present invention, a mass ratio of the distillers' grains to the water is preferably 1:(3-5). In the present invention, potassium hydroxide or acetic acid is preferably used to adjust the pH to 4.6-4.8.

In the present invention, every 10,000 enzyme activity units of the acid protease is preferably added with an amount of 0.1-0.2% of the dry mass of the adjusted distillers' grains. The present invention has no particular limitation on the source of the acid protease, and a commercially available product conventional in the art may be used. In the present invention, the adjusted distillers' grains are mixed with the acid protease, and the reaction is preferably carried out under stirring at 45-50° C. for 24 h. In the present invention, every 10,000 enzyme activity units of cellulase is preferably added with an amount of 0.2-0.5% of the dry mass of the reactant. The present invention has no special limit on the source of the cellulase, and a conventional commercial product may be used. In the present invention, the protease catalyzed substance is mixed with the cellulase, and the reaction is preferably carried out under stirring at 40-45° C. for 36 h.

The present invention has no specific limitation on filtering and conventional conditions of filtering an enzyme catalyzed substance can be employed.

In the present invention, a concentration of the MgO in the filtrate is preferably 0.2-0.4 g/L, and more preferably 0.3 g/L. In the present invention, the calcium-containing substance preferably includes calcium oxide (CaO) and/or CaCO₃, and the calcium-containing substance is added with an amount of 25-40% of the mass of the filtrate. In the present invention, the filtrate is mixed with the MgO, and then mixed with the calcium-containing substance and reacted with no bubbles coming out from the calcium-containing substance as a sign of complete reaction. In the present invention, a volume of the potassium sorbate is preferably 0.3-0.5% of that of the reactant. In the present invention, a mass of the sucrose is preferably 0.1-0.3%, and more preferably 0.2% of that of the reactant.

The present invention further provides use of the conditioner for protected agriculture acidic soil obtained by the foregoing technical solution in improving germination rate of a plant. In the present invention, the plant preferably includes garland chrysanthemum or spinach. The use method of the conditioner for protected agriculture acidic soil is not particularly limited in the present invention, and a conventional use method of a soil conditioner can be used.

The technical solutions provided by the present invention are described in detail below with reference to the examples, but the technical solutions cannot be understood as limiting the protection scope of the present invention.

### Example 1

5 kg of sorghum distillers' grains were pulverized with a pulverizer to obtain a powder with a particle size of 0.3 mm. 25 kg of water was added and stirred well. At this point, the measured pH was 3.6 and the salinity was 0.02%. 5.8 g of KOH powder was added to adjust the pH to 4.1. 0.5 ml of 150,000 U/g acid protease (Shengxia brand, APRL type) was added, mixed and stirred at 50° C. for 24 h. After reaction, the amino acid content of the reaction solution was determined to be 4.7%. KOH was added till the pH of the reaction solution reached 4.6. 2 g of 50,000 U/g cellulase (Heshibi Biotechnology Co., Ltd.) was added for treatment at an average temperature of 42° C. for 36 h. 8 g of MgO powder was added and fully dissolved. CaCO₃ powder was added until there was no bubble coming out. At this point, the reaction solution had a pH of 5.2 and a salinity of 0.13%. 7.5 g of potassium sorbate and 50 g of sucrose were added respectively and preparation of a repairing agent was completed.

The protected agriculture soil which was used for 6 consecutive years was selected for an experiment of germination of garland chrysanthemum. The soil for the experiment was in Sujiatun District of Shenyang City. The soil had significant acidification problems due to continuous cultivation of leafy vegetables for years, and a pH of 4.6 (ratio of water to soil being 1:2.5) which made it no longer capable of growing garland chrysanthemum. The above soil repairing agent was diluted 100 times and used as irrigation water for the experiment which was applied in a total amount of 3.5-5 m³/mu in 2-3 times of drip irrigation after spray irrigation to avoid flood irrigation. 10 days later, the soil pH and germination was measured. A control experiment used conventional irrigation water with an amount of irrigation water and field management and the like the same as those with the repairing agent. The grown garland chrysanthemum was a conventional variety on the market with a germination rate of 89%. The results are shown in Table 1.

TABLE 1
Experimental results of effect of the repairing agent prepared from
sorghum distillers' grains on garland chrysanthemum germination.

| | pH | | |
|---|---|---|---|
| Treatment | Before treatment | Day 10 | Germination rate |
| CK | 4.6 | 4.8 | 10% |
| Soil repairing agent | 4.6 | 5.9 | 73% |

### Example 2

3 kg of corn distillers' grains were pulverized to obtain a powder with a particle size of 0.2 mm. 15 kg of water was added and stirred well. At this point, the measured pH was 3.3 and the salinity was 0.03%. 7.8 g of KOH powder was added to adjust the pH to 4.0. 0.3 ml of 150,000 U/g acid protease (Shengxia brand, APRL type) was added, mixed and stirred at 48° C. for 24 h. After reaction, the amino acid content of the reaction solution was 3.9%. KOH was added till the pH of the reaction solution reached 4.4. 1.2 g of 50,000 U/g cellulase (Heshibi Biotechnology Co., Ltd.) was added for treatment at an average temperature of 42° C. for 36 h. 6 g of MgO powder was added and fully dissolved. CaCO₃ powder was added until there was no bubble coming out. At this point, the reaction solution had a pH of 5.1 and a salinity of 0.17%. 4.5 g of potassium sorbate and 30 g of sucrose were added respectively to obtain a soil repairing agent prepared from corn distillers' grains.

The protected agriculture soil which had been used for continuous farming for 11 years in Liaozhong District of Shenyang City was used for an experiment to test an improvement effect on spinach. The pH of the soil before treatment was 4.9 (ratio of water to soil being 1:2.5). The soil repairing agent prepared from the corn distillers' grains was used for the germination experiment which specifically carried out as follows: the soil for the experiment was screened through a 2 mm sieve and used as a soil for seedling. A seedbed was made with evenly laid soil. Seeds were laid at a depth of 0.5 cm and then covered with original soil. The repairing agent was diluted 100 times and used as irrigation water which was evenly sprayed. A plastic film was applied for coverage. Emergence was observed from time to time. After 7 days, the overall germination rate was calculated. The plant for the experiment was spinach which was commercially available with a germination rate of 94%. The results are shown in Table 2.

TABLE 2
Experimental results of effect of the repairing agent prepared
from corn distillers' grains on spinach germination.

| | pH | | |
|---|---|---|---|
| Treatment | Before treatment | Day 10 | Germination rate |
| CK | 4.9 | 4.7 | <5% |
| Soil repairing agent | 4.9 | 5.5 | 62% |

Through the experiments of effects of improvement of acidic soil on the two common leaf vegetables, it can be found that the soil conditioner produced after the treatment on sorghum and corn distiller's grains of the present invention can increase the pH of the protected agriculture acidic soil and increase the germination rates of the two leaf vegetables, the garland chrysanthemum and the spinach compared with control, showing a significant technical advantage. At the same time, the product can be directly applied with irrigation water, thereby reducing additional input in improving protected agriculture acidic soil, which showed production convenience.

The above descriptions are merely preferred implementations of the present invention. It should be noted that a person of ordinary skill in the art may further make several improvements and modifications without departing from the principle of the present invention, but such improvements and modifications should be deemed as falling within the protection scope of the present invention.

What is claimed is:

1. A method of preparing a conditioner for protected agriculture acidic soil with distillers' grains, comprising the following steps:
step 1): mixing distillers' grains with water, adjusting a pH to 4-4.2 to obtain adjusted distillers' grains;
step 2): mixing the adjusted distillers' grains obtained in step 1) with an acid protease, and reacting under stirring at 45-50° C. for 22-26 h to obtain a protease catalyzed substance;
step 3): adjusting pH of the protease catalyzed substance in step 2) to 4.6-4.8, mixing with a cellulase, and reacting under stirring at 40-45° C. for 34-38 h to obtain a cellulase catalyzed substance; and,
step 4): filtering the cellulase catalyzed substance obtained in step 3) to obtain a filtrate, mixing the filtrate with a magnesium oxide (MgO) and then a calcium-containing substance, reacting to obtain a reactant, and mixing the reactant with potassium sorbate and sucrose to obtain the conditioner for protected agriculture acidic soil.

2. The method according to claim 1, wherein in step 1), a mass ratio of the distillers' grains to the water is 1:(3-5).

3. The method according to claim 1, wherein the distillers' grains have a particle size of 0.3-0.5 mm.

4. The method according to claim 2, wherein the distillers' grains have a particle size of 0.3-0.5 mm.

5. The method according to claim 1, wherein in step 2), every 10,000 enzyme activity units of the acid protease is added with an amount of 0.1-0.2% of the dry mass of the adjusted distillers' grains.

6. The method according to claim 1, wherein in step 3), every 10,000 enzyme activity units of cellulase is added with an amount of 0.2-0.5% of the dry mass of the reactant.

7. The method according to claim 1, wherein in step 4), a concentration of the MgO in the filtrate is 0.2-0.4 g/L.

8. The method according to claim 1, wherein:
the calcium-containing substance comprises calcium oxide (CaO) and/or calcium carbonate (CaCO₃); and,
the calcium-containing substance is added with an amount of 25-40% of the mass of the filtrate.

9. The method according to claim 1, wherein in step 4), a volume of the potassium sorbate is 0.3-0.5% of that of the reactant.

10. The method according to claim 1, wherein in step 4), a mass of the sucrose is 0.1-0.3% of that of the reactant.

11. Use of a conditioner for protected agriculture acidic soil obtained by the method according to claim 1 in improving a germination rate of a plant.

12. Use of a conditioner for protected agriculture acidic soil obtained by the method according to claim 2 in improving a germination rate of a plant.

13. Use of a conditioner for protected agriculture acidic soil obtained by the method according to claim 3 in improving a germination rate of a plant.

14. Use of a conditioner for protected agriculture acidic soil obtained by the method according to claim 4 in improving a germination rate of a plant.

15. Use of a conditioner for protected agriculture acidic soil obtained by the method according to claim 5 in improving a germination rate of a plant.

16. Use of a conditioner for protected agriculture acidic soil obtained by the method according to claim 6 in improving a germination rate of a plant.

17. Use of a conditioner for protected agriculture acidic soil obtained by the method according to claim 7 in improving a germination rate of a plant.

18. Use of a conditioner for protected agriculture acidic soil obtained by the method according to claim 8 in improving a germination rate of a plant.

19. Use of a conditioner for protected agriculture acidic soil obtained by the method according to claim 9 in improving a germination rate of a plant.

20. Use of a conditioner for protected agriculture acidic soil obtained by the method according to claim 10 in improving a germination rate of a plant.
